(19) United States
(12) Patent Application Publication
(10) Pub. No.: US 2014/0014448 A1
(43) Pub. Date: Jan. 16, 2014

(54) DISC BRAKE

(71) Applicant: Dr. Ing. h.c. F. Porsche Aktiengesellschaft, Stuttgart (DE)

(72) Inventors: Michael Kautenburger, Weissach (DE); Michael Wolff, Recklinghausen (DE); Thomas Lenz, Stuttgart (DE)

(73) Assignee: Dr. Ing. h.c. F. Porsche Aktiengesellschaft, Stuttgart (DE)

(21) Appl. No.: 13/938,862

(22) Filed: Jul. 10, 2013

(30) Foreign Application Priority Data
Jul. 13, 2012 (DE) 102012106304.4

(51) Int. Cl. F16D 65/12

(52) U.S. Cl. CPC F16D 65/127
USPC 188/218 XL

(57) ABSTRACT

A brake disc comprising a friction surface which has regions comprising recesses, wherein the recesses can vary in the circumferential direction in such a manner that the recesses are formed and/or are arranged such that the recesses in total in the radial direction do not exert any transverse forces on the brake pad.

### CROSS-REFERENCE TO RELATED APPLICATIONS

This application claims priority of German Patent Application No. 10 2012 106304.4, filed Jul. 13, 2012, which is incorporated by reference herein in its entirety.

### FIELD OF INVENTION

The invention relates to a brake disc comprising a friction surface which has regions comprising recesses.

### BACKGROUND

German laid-open application DE 10 2006 017 207 A1 discloses a brake disc for a motor vehicle disc brake having a smooth-surface contour at the friction surfaces. The smooth-surface contour has spirally running grooves. The brake disc forms at least two sections having an opposed direction of rotation of the spiral shape. There may be a plurality of interrupted and/or intersecting grooves per section.

### SUMMARY

It is the object of the invention to optimize a brake disc comprising a friction surface, which has regions comprising recesses, in respect of a wet coefficient of friction during the operation of the brake disc.

The object is achieved, in a brake disc comprising a friction surface which has regions comprising recesses, in that the recesses can vary in the circumferential direction in such a manner that the recesses are formed and/or are arranged such that the recesses in total in the radial direction do not exert any transverse forces on the brake pad. Owing to the fact that the recesses in the radial direction do not exert any transverse forces on the brake pad and vary in the circumferential direction, the pad surface can be prevented from cutting into the disc surface. The brake disc according to the invention is preferably of perforated design and ventilated on the inside. The formation and arrangement of the recesses in the friction surface make it possible to improve the drainage of water from the friction surface of the brake disc. The wet coefficient of friction of the brake disc can be considerably improved as a result. The terms axially, radially and in the circumferential direction refer to an axis of rotation of the brake disc. Axially means in the direction of or parallel to the axis of rotation. Radially means transversely with respect to the axis of rotation.

For example, the regions comprising the recesses in the friction surface can have a shape in the form of an arc of a circle or an undulating shape and are arranged spaced apart from one another in the circumferential direction of the brake disc. For example, the recesses and/or subregions of a recess can be arranged running concentrically or not concentrically with respect to the center of the wheel. The brake disc according to the invention is preferably formed from a ceramic material. A disc brake provided with the brake disc according to the invention made from the ceramic material is also referred to as a ceramic brake.

It is furthermore conceivable for the regions comprising the recesses in the friction surface to have a herringbone shape and/or V shape and to be arranged spaced apart from one another in the circumferential direction of the brake disc. The shaping possibilities enumerated here should be understood merely as an exemplary enumeration; further forms or geometries are conceivable, as long as the transverse forces applied through the recess to the pad can continue to be compensated for by additional recesses opposing the transverse forces.

For example, the recess can be formed by a single channel-like depression, or a plurality of channel-like depressions which are arranged next to one another and can have identical or non-uniform cross sections, for example with angular and/or rounded upper and/or lower edges, can be provided. For example, by means of a plurality of recesses arranged next to one another, profiles which are undulating or zigzag-shaped in cross section can be produced.

A preferred exemplary embodiment of the brake disc is characterized in that a plurality of regions comprising the recesses in the friction surface are distributed uniformly in the circumferential direction of the brake disc. According to one essential aspect of the invention, the regions comprising the recesses of the friction surface are not formed continuously, but in an interrupted manner, in the circumferential direction in order to avoid the pad surface cutting into the disc contour. A plurality of regions comprising the recesses in the friction surface are spaced apart from one another uniformly or non-uniformly in the circumferential direction.

For example, provision may be made to provide only one friction surface side of the brake disc with recesses.

A further preferred exemplary embodiment of the brake disc is characterized in that a plurality of regions comprising the recesses in the friction surface are spaced apart from one another in the radial direction of the brake disc. The regions comprising the recesses in the friction surface are preferably likewise distributed uniformly, in particular spaced apart from one another uniformly, in the radial direction of the brake disc.

A further preferred exemplary embodiment of the brake disc is characterized in that the regions which are spaced apart from one another in the radial direction of the brake disc and comprise the recesses are arranged offset from one another in the circumferential direction. The offset arrangement has proven advantageous in respect of pad vibrations occurring during the operation of the brake disc.

A further preferred exemplary embodiment of the brake disc is characterized in that the regions which are spaced apart from one another in the radial direction of the brake disc and comprise the recesses are arranged offset from one another in the circumferential direction in such a manner that an alternating arrangement is produced. By means of the alternating arrangement, undesirable pad vibrations, which are caused by brake pads approaching the friction surface and moving away from the friction surface, are avoided.

A further preferred exemplary embodiment of the brake disc is characterized in that the recesses in the regions of the friction surface are in the form of grooves which have the shape of arcs of a circle. In a region of the friction surface, a plurality of grooves are preferably in each case spaced apart from one another in the radial direction. In the regions of the friction surfaces, the grooves are preferably spaced apart uniformly from one another in the radial direction.

A further preferred exemplary embodiment of the brake disc is characterized in that the regions comprising the recesses in the friction surface are in each case delimited at the beginning and at the end, as viewed in the circumferential direction, by a through-hole which leads into one of a plurality of cooling ducts in the interior or the brake disc. The cooling ducts serve to provide internal ventilation of the brake. The through-holes are preferably designed as perforation bores. By means of the arrangement of the through-holes at the beginning and at the end of the regions comprising the recesses in the friction surface, a drainage effect of the through-holes, which is brought about by the flow passing through the cooling ducts, can be particularly advantageously used in order to drain water from the friction surface of the brake disc.

A further preferred exemplary embodiment of the brake disc is characterized in that the regions comprising the recesses in the friction surface are delimited radially on the inside by a first radius and radially on the outside by a second radius which is larger by a diameter of the through-holes than the first radius. As a result, the suction effect of the through-holes can be particularly effectively concentrated in the regions comprising the recesses in the friction surface.

A further preferred exemplary embodiment of the brake disc is characterized in that the recesses in the friction surface have a depth of between a few hundredths of a millimeter and a few millimeters. These values have proven particularly advantageous in investigations carried out within the context of the present invention.

A further preferred exemplary embodiment of the brake disc is characterized in that the depth of the recesses in the friction surface, as viewed in the circumferential direction, is not constant, but rather increases or decreases. The depth of the recesses can constantly increase or decrease from the beginning to the end of the respective region. The depth of the recesses can also increase and decrease in an alternating manner in a region.

Further advantages, features and details of the invention emerge from the description below, in which various exemplary embodiments are described in detail with reference to the drawing, in which:

### BRIEF DESCRIPTION OF THE DRAWINGS

FIG. 1 shows a greatly simplified illustration of a brake disc with internal ventilation in section;

FIG. 2 shows the brake disc from FIG. 1 in top view according to a first exemplary embodiment;

FIG. 3 shows a similar illustration as in FIG. 2 according to a second exemplary embodiment;

FIG. 4 shows a simplified and enlarged illustration of a region comprising recesses from FIG. 3, and

FIG. 5 shows the region from FIG. 4 in cross section.

### DETAILED DESCRIPTION

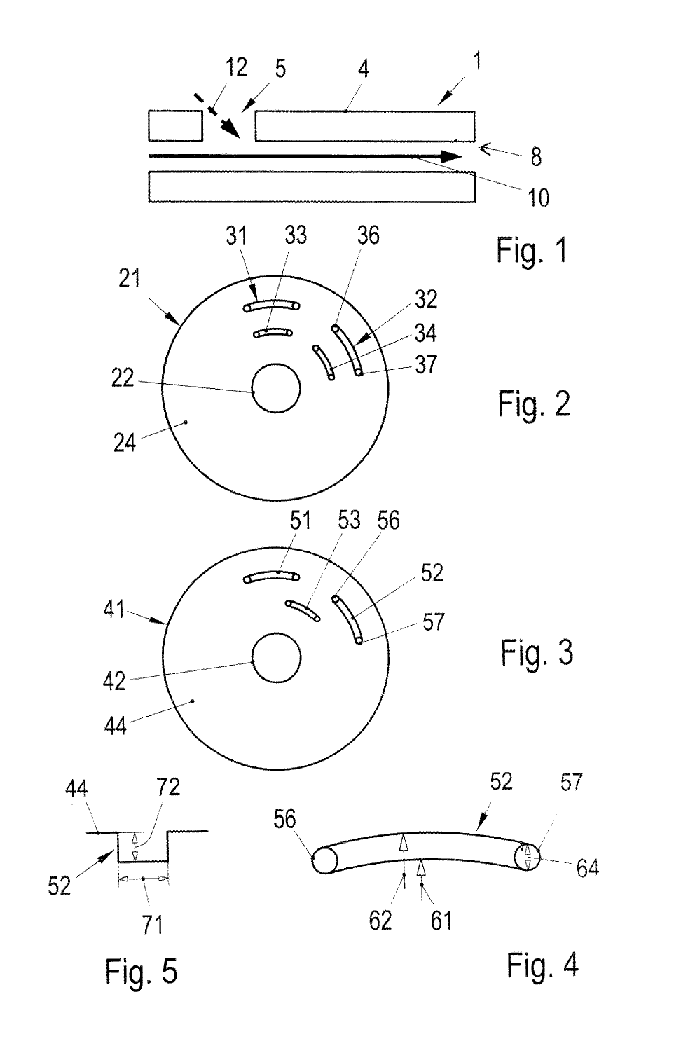

FIG. 1 illustrates a brake disc 1 comprising a friction surface 4 in greatly simplified form and in section. A through-hole 5 which leads into a cooling duct 8 in the interior of the brake disc 1 is left open in the friction surface 4. The flow of a cooling medium, such as air, through the cooling duct 8 is indicated by an arrow 10. A drainage effect from the friction surface 4 through the through-hole 5 into the cooling duct 8 is indicated by a dashed arrow 12.

The brake disc 1 is formed from a ceramic composite material. Brake discs of this type are also known under the name PORSCHE Ceramic Composite Brake (PCCB). The design according to the invention of the brake disc 1 makes it possible for water to drain from the friction surface 4 through the through-hole 5 into the cooling duct 8. A wet coefficient of friction of the ceramic brake can thereby be improved in comparison to brakes having brake discs made from gray cast iron material.

FIG. 2 illustrates a brake disc 21 according to a first exemplary embodiment in top view. The brake disc 21 comprises a central opening 22 which is surrounded by a friction surface 24. A multiplicity of regions 31, 32, 33, 34 comprising recesses are formed in the friction surface 24.

Only four regions 31 to 34 of a multiplicity (not illustrated) of regions are illustrated by way of example and provided with reference numbers in FIG. 2. All of the recesses are arranged distributed uniformly over the friction surface 24.

The regions 31 to 34 are in the shape of arcs of a circle. Each of the regions 31 to 34 has in each case a through-hole 36, 37 at the beginning and at the end, as viewed in the circumferential direction. A multiplicity of grooves which likewise have the shape of arcs of a circle extend in the respective region 32 between the through-holes 36, 37.

In the exemplary embodiment illustrated in FIG. 2, the regions 31 and 33; 32 and 34 are arranged overlapping in the circumferential direction. A clearance, in which the friction surface 24 is not provided with recesses, is in each case left free in the circumferential direction between two regions 31, 32 and 33, 34.

The drainage effect which is indicated by the dashed arrow 12 in FIG. 1 leads to increased water being able to be conducted away from the friction surface, with, in consequence, the friction pad approaching the friction surface 24 in the regions 31, 33 and 32, 34. The friction pad moves way from the friction surface 24 in the circumferential direction between the regions 31, 33 and 32, 34.

FIG. 3 illustrates a brake disc 41 comprising a friction surface 44 and a central opening 42 in top view. Three regions 51, 52, 53 comprising recesses which each have the shape of arcs of a circle are indicated in the friction surface 44.

Each of the regions 51 to 53 is delimited at the beginning and at the end, as viewed in the circumferential direction, by a through-hole 56, 57. Between the through-holes 56, 57, each region 51 to 53 comprises a multiplicity of grooves which likewise have the shape of arcs of a circle.

In contrast to the exemplary embodiment illustrated in FIG. 2, in FIG. 3 the regions 51, 52 and 53 are arranged offset from one another, as viewed in the circumferential direction. This results in an alternating arrangement of the regions 51, 53 and 52.

By means of the alternating arrangement illustrated in FIG. 3, undesirable pad vibrations, as may occur in the case of the exemplary embodiment illustrated in FIG. 2, can be avoided in a simple manner.

FIG. 4 illustrates the region 52 with the two through-holes 56 and 57 on an enlarged scale and without the grooves between the through-holes 56 and 57. A first radius of the region 52 is indicated by an arrow 61. A second radius of the region 52 is indicated by an arrow 62.

A diameter of the through-hole 57 is indicated by a double arrow 64. The through-hole 56 has the same diameter as the through-hole 57. The second radius 62 is larger by the diameter 64 than the first radius 61.

FIG. 5 illustrates the region 52 in cross section without grooves. The width of the region 52 is indicated by a double arrow 71. The depth of the region 52 is indicated by a double arrow 72.

The depth 72 of the region 52 is between one tenth of a millimeter and one millimeter. The width 71 of the region 52 is, for example, 0.5 millimeters.

The width 71 of the region 52 can be smaller than the diameter 64. However, the width 71 of the region 52 is in principle not connected to the diameter 64 of the through-hole 57.

What is claimed:

1. A brake disc comprising a friction surface which has regions comprising recesses, wherein the recesses vary in a circumferential direction such that the recesses are formed and/or are arranged such that the recesses in total in the radial direction do not exert any transverse forces on the brake pad.

2. The brake disc as claimed in claim 1, wherein the regions comprising the recesses in the friction surface have a shape in the form of an arc of a circle and/or an undulating shape and are arranged spaced apart from one another in the circumferential direction of the brake disc.

3. The brake disc as claimed in claim 1, wherein the regions comprising the recesses in the friction surface have a herringbone shape and/or V shape and are arranged spaced apart from one another in the circumferential direction of the brake disc.

4. The brake disc as claimed in claim 1, wherein a plurality of regions comprising the recesses in the friction surface are distributed uniformly in the circumferential direction of the brake disc.

5. The brake disc as claimed in claim 1, wherein the recesses are interrupted in the circumferential direction such that a plurality of recesses arranged distributed uniformly or non-uniformly are produced in a regular or irregular arrangement with respect to one another.

6. The brake disc as claimed in claim 1, wherein a plurality of regions comprising the recesses in the friction surface are spaced apart from one another in the radial direction of the brake disc.

7. The brake disc as claimed in claim 6, wherein the regions which are spaced apart from one another in the radial direction of the brake disc and comprise the recesses are arranged offset from one another in the circumferential direction.

8. The brake disc as claimed in claim 7, wherein the regions which are spaced apart from one another in the radial direction of the brake disc and comprise the recesses are arranged offset from one another in the circumferential direction in such a manner that an alternating arrangement is produced.

9. The brake disc as claimed in claim 1, wherein the recesses in the regions of the friction surface are in the form of grooves which have the shape of arcs of a circle.

10. The brake disc as claimed in claim 1, wherein the regions comprising the recesses in the friction surface are in each case delimited at the beginning and at the end, as viewed in the circumferential direction, by a through-hole which leads into one of a plurality of cooling ducts in the interior or the brake disc.

11. The brake disc as claimed in claim 9, wherein the regions comprising the recesses in the friction surface are delimited radially on the inside by a first radius and radially on the outside by a second radius which is larger by a diameter of the through-holes than the first radius.

12. The brake disc as claimed in claim 1, wherein the recesses in the friction surface have a depth of between one tenth of a millimeter and one millimeter.

13. The brake disc as claimed in claim 11, wherein the depth of the recesses in the friction surface, as viewed in the circumferential direction, is not constant, but rather increases or decreases.
